(19) United States
(12) Patent Application Publication
(10) Pub. No.: US 2021/0185772 A1
(43) Pub. Date: Jun. 17, 2021

(54) ENERGY REDUCTION HEATING APPARATUS AND OPERATION METHOD THEREOF

(71) Applicant: LG ELECTRONICS INC., Seoul (KR)

(72) Inventor: Taehyun KIM, Seoul (KR)

(73) Assignee: LG ELECTRONICS INC., Seoul (KR)

(21) Appl. No.: 16/822,810

(22) Filed: Mar. 18, 2020

(30) Foreign Application Priority Data
Dec. 11, 2019 (KR) 10-2019-0164745

(51) Int. Cl. H05B 6/06; H05B 6/12; G01H 11/06; G06N 3/08; G05D 23/19; F24C 7/08

(52) U.S. Cl. CPC H05B 6/062; H05B 6/1236; G01H 11/06; H05B 2213/04; G05D 23/1919; F24C 7/087; H05B 2213/07; G06N 3/08

(57) ABSTRACT

An energy reduction heating apparatus for estimating that an object to be heated is in a boiling state based on vibration information of the object periodically sensed by a vibration sensor, and controlling the amount of electric power supplied to a heater for heating the object based on the comparison result between the intensity of vibration sensed by the vibration sensor and the intensity of vibration corresponding to the boiling state. The energy reduction heating apparatus estimates the boiling state of the object by applying a vibration-based boiling state estimation algorithm to the vibration information. The vibration-based boiling state estimation algorithm can be a neural network model generated through machine learning, can be stored in a memory in the energy reduction heating apparatus, or can be provided through a server in an artificial intelligence environment over a 5G network.

### CROSS-REFERENCE TO RELATED APPLICATION

This present application claims benefit of priority to Korean Patent Application No. 10-2019-0164745, entitled “ENERGY REDUCTION HEATING APPARATUS AND OPERATION METHOD THEREOF,” filed on Dec. 11, 2019, in the Korean Intellectual Property Office, the entire disclosure of which is incorporated herein by reference.

### BACKGROUND

### 1. Technical Field

The present disclosure relates to an energy reduction heating apparatus and method capable of controlling the amount of electric power supplied to a heater configured to heat an object to be heated based on changes in a vibration pattern generated as the object is heated.

### 2. Description of Related Art

When food is heated for cooking, if heating continues without continuous monitoring, the food can be overheated and thus charred, burnt, or evaporated, or in a serious case, a fire can be caused.

Accordingly, there have been technical attempts to automatically control or stop the operation of a heater by sensing an excessive rise in temperature.

Korean Patent Registration No. 1390397 relating to “Apparatus and method for controlling safety cooking appliance” discloses a method for reducing the amount of heating or shutting off the heating when food boils over, by using a CCD camera installed on the main body of the heater to capture images of the food being cooked, and analyzing the captured images.

The technology disclosed in the above document can be capable of preventing the food from boiling over, but can result in a sudden drop in the temperature of the food, thus being unable to maintain a steady temperature of the food.

Korean Patent Registration No. 1849099 relating to a “Boil and boil dry detection apparatus” discloses a method for determining that water is boiling by detecting vibration of a cooking container placed on a cooking device by using an ultrasonic apparatus transmitting transmission ultrasonic signals toward the cooking container, and an ultrasonic receiver receiving reflected ultrasonic signals reflected and returned from the cooking container.

The technology disclosed in the above document requires the additional installation of the ultrasonic apparatus and the ultrasonic receiver apart from the heater, and also can suffer from a reduced estimation accuracy as different types of cooking containers have different vibration frequencies.

To overcome the above limitations, it is necessary to provide improvements in methods of sensing a heating environment while heating an object, such as in cooking, and automatically controlling the amount of heating based on the sensed result.

### SUMMARY OF THE PRESENT DISCLOSURE

An aspect of the present disclosure is to enable an easy estimation of the boiling state of an object (for example, food or any kind of liquid) to be heated by applying a vibration-based boiling state estimation algorithm to vibration information sensed by a vibration sensor.

Another aspect of the present disclosure is to estimate the object to be in a boiling state based on vibration information periodically sensed by a vibration sensor when operating in an energy saving mode, and to reduce unnecessary consumption of energy while maintaining the object in the boiling state, by decreasing or increasing the amount of electric power being supplied to a heater heating the object based on the result of comparison between the vibration intensity sensed by the vibration sensor and a vibration intensity corresponding to the boiling state of the object.

Another aspect of the present disclosure is to determine that, when operating in a non-energy saving mode, even when the object is continuously estimated to being a boiling state, this continuous heating is intended by the user, so even if the result of monitoring the state of the object based on vibration information indicates that the object is turning into an undesirable state (for example, excessively boiled down or burned), rather than reducing the amount of electric power supplied to the heating member heating the object, the user is provided with a warning notification about the object that allows the user to be aware of the state of the object.

An embodiment of the present disclosure provides an energy reduction heating apparatus including a housing having therein a storage space, a heater configured to heat an object to be heated, a power supply configured to supply electric power to the heater, a top plate disposed at an upper part of the housing and configured to support the object, a vibration sensor disposed at a lower part of the top plate, and a controller configured to control the amount of electric power supplied from the power supply to the heater based on vibration information sensed by the vibration sensor.

Another embodiment of the present disclosure provides a method of operating an energy reduction heating apparatus, the method including heating, by a heater in the energy reduction heating apparatus, an object to be heated disposed on a top plate of the energy reduction heating apparatus, sensing, by a vibration sensor in the energy reduction heating apparatus, vibration information, and controlling, by a controller in the energy reduction heating apparatus, the amount of electric power supplied to the heater based on the sensed vibration information.

In addition to these embodiments, another method and system for implementing the present disclosure, and a computer-readable recording medium storing a computer program for executing the method can be further provided.

The above and other aspects, features, and advantages of the present disclosure will become apparent from the detailed description of the following aspects in conjunction with accompanying drawings.

As is apparent from the above description, according to embodiments of the present disclosure, the temperature of an object being heated can be easily estimated by applying a vibration-based boiling state estimation algorithm to vibration information sensed by a vibration sensor, and the boiling state of the object can be easily estimated based on the estimated temperature of the object.

According to embodiments of the present disclosure, when operating in an energy saving mode, the boiling state of the object can be estimated based on vibration information periodically sensed by the vibration sensor, and any unnecessary consumption of energy can be reduced while maintaining the boiling state (or a predetermined temperature range) of the object, by decreasing or increasing the amount of electric power supplied to a heater heating the object based on the result of comparison between the intensity of vibration sensed by the vibration sensor and the intensity of vibration corresponding to the boiling state.

In addition, according to embodiments of the present disclosure, while operating in a non-energy saving mode, even when the object is estimated to be continuously in a boiling state, a determination can be made that this continuous boiling is intended by the user, such that the amount of electric power supplied to the heater heating the object is not decreased. However, as a result of monitoring the state of the object based on the vibration information, it is estimated that the object will turn into a state that is not desired or intended by the user, for example, boiled down or burned, a warning notification about the object can be provided to the user so that the user can be made aware of the state of the object.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a diagram illustrating an environment in which an energy reduction heating apparatus according to an embodiment of the present disclosure is operated.

FIG. 2 is an exploded diagram of an energy reduction heating apparatus according to another embodiment of the present disclosure.

FIG. 3 is a block diagram showing the construction of an energy reduction heating apparatus according to another embodiment of the present disclosure.

FIGS. 4 and 5 are diagrams illustrating vibration information sensed by the energy reduction heating apparatus according to an embodiment of the present disclosure.

FIG. 6 is a diagram illustrating a neural network model for estimating a boiling state of an object to be heated in the energy reduction heating apparatus according to an embodiment of the present disclosure.

FIG. 7 is a diagram illustrating an example in which the energy reduction heating apparatus according to an embodiment of the present disclosure controls an amount of electric power supplied to a heater based on changes in the state of the object.

FIG. 8 is a diagram illustrating an example in which the energy reduction heating apparatus according to an embodiment of the present disclosure provides a warning notification in response to a change in the state of the object.

FIG. 9 is a diagram illustrating an example in which an energy reduction heating apparatus according to another embodiment of the present disclosure controls an amount of electric power supplied when heating a plurality of objects.

FIG. 10 is a flowchart showing an operation method of the energy reduction heating apparatus according to an embodiment of the present disclosure.

### DETAILED DESCRIPTION

The embodiments disclosed in the present specification will be described in greater detail with reference to the accompanying drawings, and throughout the accompanying drawings, the same reference numerals are used to designate the same or similar components and redundant descriptions thereof are omitted. As used herein, the terms “module” and “unit” used to refer to components are used interchangeably in consideration of convenience of explanation, and thus, the terms per se should not be considered as having different meanings or functions. In the following description of the embodiments disclosed herein, the detailed description of related known technology will be omitted when it can obscure the subject matter of the embodiments according to the present disclosure. Further, the accompanying drawings are provided for more understanding of the embodiment disclosed in the present specification, but the technical spirit disclosed in the present disclosure is not limited by the accompanying drawings. It should be understood that all changes, equivalents, and alternatives included in the spirit and the technical scope of the present disclosure are included.

Although the terms first, second, third, and the like can be used herein to describe various elements, components, regions, layers, and/or sections, these elements, components, regions, layers, and/or sections should not be limited by these terms. These terms are generally only used to distinguish one element from another.

When an element or layer is referred to as being “on,” “engaged to,” “connected to,” or “coupled to” another element or layer, it can be directly on, engaged, connected, or coupled to the other element or layer, or intervening elements or layers can be present. In contrast, when an element is referred to as being “directly on,” “directly engaged to,” “directly connected to,” or “directly coupled to” another element or layer, there can be no intervening elements or layers present.

As used herein, the singular forms “a,” “an,” and “the” are intended to include the plural forms as well, unless the context clearly indicates otherwise.

It should be understood that the terms “comprises,” “comprising,” “includes,” “including,” “containing,” “has,” “having” or any other variation thereof specify the presence of stated features, integers, steps, operations, elements, and/or components, but do not preclude the presence or addition of one or more other features, integers, steps, operations, elements, and/or components.

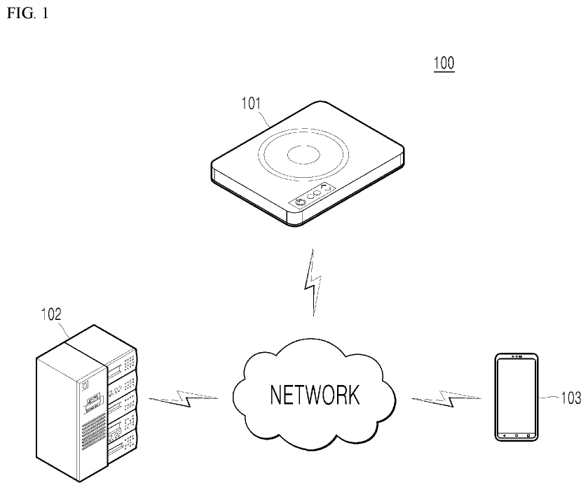

FIG. 1 is a diagram illustrating an environment in which an energy reduction heating apparatus according to an embodiment of the present disclosure is operated.

The energy reduction heating apparatus according to the present disclosure can be an appliance having various heating means (e.g., a cooktop, a stove top, a portable heating means or the like). For convenience of description however, embodiments will be described on the assumption that an example of the energy reduction heating apparatus is an electric range.

The environment 100 in which the energy reduction heating apparatus is operated can include, for example, an electric range 101, a server 102, and a user terminal 103.

The electric range 101 can operate in an Internet of Things (IoT) environment constructed by using a 5G communication network. The electric range 101 can communicate with the server 102, the user terminal 103, and a speaker.

The electric range 101 can sense vibration information, such as a vibration pattern, generated as heating an object, through a vibration sensor, and by applying a vibration-based boiling state estimation algorithm to the vibration information, can easily estimate the boiling state of the object. The electric range 101 can control the amount of electric power that is supplied to the object by decreasing or increasing the amount of electric power being supplied to a heater configured to heat the object based on the result of comparison between both the vibration intensity sensed by the vibration sensor and a vibration intensity corresponding to the boiling state.

As another example, the electric range 101 can sense vibration information (e.g. a vibration pattern) generated as the object is heated, through the vibration sensor, and can estimate the temperature of the object by applying a vibration-based temperature estimation algorithm to the vibration information, and based on the temperature of the object, can control the amount of electric power being supplied to the object.

The electric range 101 can generate the vibration-based boiling state estimation algorithm, or the vibration-based temperature estimation algorithm, or can receive the algorithm from the server 102 and store the received algorithm in a memory.

Meanwhile, if the vibration information corresponds to a predetermined condition, the electric range 101 can provide a warning notification about the object through an internal component or the speaker, or can provide the warning notification to the user terminal 103. For example, if a vibration period in the vibration information exceeds a predetermined reference period over a predetermined time, the vibration intensity in the vibration information exceeds a predetermined reference intensity over a predetermined time, or the temperature of the object exceeds a predetermined reference temperature over a predetermined time, the electric range 101 can determine that the object will turn into an undesirable state (for example, becoming too boiled down, that is, heated to too high of a temperature or too concentrated) against the user's intention, and can provide a warning notification about the object through the internal component or can provide the warning notification to the user terminal 103.

During heating of the object, the server 102 can receive vibration information (such as a vibration pattern including at least one of a vibration period, a vibration intensity, or a vibration waveform) sensed by the electric range 101, or the boiling state of the object (or the temperature of the object) as estimated based on the vibration information from the electric range 101, and can store the received vibration information or the estimated boiling state in a database, and through an accumulated database (e.g., the database accumulating the received vibration information and/or the estimated boiling state), can provide a power supply control determination criterion for energy saving to the electric range 101, based on the vibration information or the boiling state of the object (or the temperature of the object).

For example, the server 102 can further store in the database, in the form of an energy table, amounts of energy supply associated with the vibration information generated as the object is heated or the boiling state of the object (or the temperature of the object) associated with the vibration information. The electric range 101 can sense the vibration information generated as the object is heated, or can estimate the boiling state of the object (or the temperature of the object) from the vibration information, and can acquire the amount of energy to be supplied to the object by referring to the energy table in the server 102 through communication with the server 102, and control the amount of electric power to be supplied based on the acquired amount of energy supply.

In addition, the server 102 can provide the vibration-based boiling state estimation algorithm (or the vibration-based temperature estimation algorithm) to the electric range 101 such that the electric range 101 easily estimates the boiling state of the object (or the temperature of the object).

In addition, the server 102 can communicate with a plurality of electric ranges to collect the amount of energy supply based on the boiling state of the object (or the temperature of the object), thereby updating information in the database.

If the vibration information sensed by the electric range 101 corresponds to a predetermined condition, the user terminal 103 can receive the warning notification about the object from the electric range 101.

In addition, the user terminal 103 can include a communication terminal capable of performing the function of a computing device, and can be, but is not limited to, a desktop computer, a smartphone, a notebook computer, a tablet PC, a smart TV, a cell phone, a personal digital assistant (PDA), a laptop computer, a media player, a micro server, a global positioning system (GPS) device, an electronic book terminal, a digital broadcast terminal, a navigation device, a kiosk, an MP3 player, a digital camera, a home appliance, and other mobile or stationary computing devices manipulated by the user.

Also, the user terminal 103 can be a wearable terminal implemented with communication functionality and data processing functionality, such as a wearable watch, wearable glasses, a wearable hairband, a wearable bracelet, a wearable ring, and the like. The user terminal 103 is not limited thereto, and any terminal capable of recognizing a notification can be used without limitation.

The electric range 101 can be connected to the above devices over a network. Here, the network can serve to connect the electric range 10, the server 102, and the user terminal 103 to each other.

The network can include a wired network such as a local area network (LAN), a wide area network (WAN), a metropolitan area network (MAN), or an integrated service digital network (ISDN), and a wireless network such as a wireless LAN, a CDMA, Bluetooth®, or satellite communication, but the present disclosure is not limited to these examples.

Further, the network can transmit and receive information by using near-field communication and/or remote communication. The short distance communication can include Bluetooth®, radio frequency identification (RFID), infrared data association (IrDA), ultra-wideband (UWB), ZigBee®, and Wi-Fi (wireless fidelity) technologies, and the long distance communication can include code division multiple access (CDMA), frequency division multiple access (FDMA), time division multiple access (TDMA), orthogonal frequency division multiple access (OFDMA), and single carrier frequency division multiple access (SC-FDMA).

The network can include connection of network elements such as hubs, bridges, routers, switches, and gateways. The network can include one or more connected networks, such as a multiple network environment, including a public network such as the Internet and a private network such as a secure corporate private network. Access to the network can be provided via one or more wired or wireless access networks.

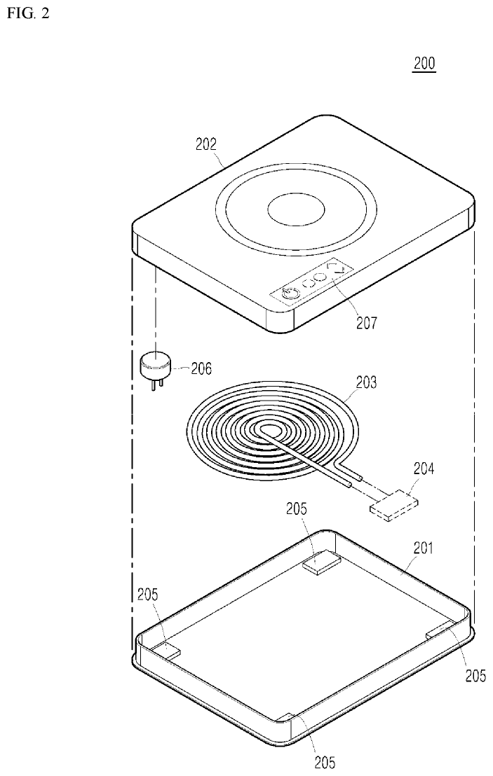

FIG. 2 is an exploded diagram of an energy reduction heating apparatus according to another embodiment of the present disclosure.

Referring to FIG. 2, the energy reduction heating apparatus 200 can include a housing 201 having therein a storage space, a heater 203 disposed in the housing 201 to heat an object to be heated, a power supply 204 configured to supply electric power to the heater 203, a top plate 202 disposed at an upper part of the housing 201 to support the object, a vibration sensor 206 disposed at a lower part of the top plate 202, and an interface 207 configured to receive an instruction from a user.

In addition, the energy reduction heating apparatus 200 can further include a weight sensor 205 disposed in the housing 201 to measure the weight of the object disposed on the top plate 202. The weight sensor 205 can be disposed in plurality and further can be disposed at corners of the housing 201. For example, the energy reduction heating apparatus 200 can include four (4) weight sensors 205, each of the four weight sensors being disposed at a respective corner of the housing 201, as shown in FIG. 2. However, any number of weight sensors 205 can be disposed in the housing 201.

The energy reduction heating apparatus 200 can include a controller configured to estimate the boiling state of the object (or the temperature of the object) based on vibration information received from the vibration sensor 206, and to control the amount of electric power supplied from the power supply 204 to the heater 203 based on the estimated boiling state of the object (or the estimated temperature of the object).

The controller can prevent unnecessary consumption of electric power and thereby conserve energy by adjusting the number of coils supplying electric power, among a plurality of coils in the heater 203, based on the temperature of the object. At this time, the operation mode of the energy reduction heating apparatus 200 can be an energy saving mode. The energy saving mode can be set as a default operation mode of the energy reduction heating apparatus 200; however, the present disclosure is not limited thereto. For example, by a user request through the interface 207, the default operation mode of the energy reduction heating apparatus 200 can be modified and set to the non-energy saving mode, or the energy reduction heating apparatus 200 can be switched from the energy saving mode to the non-energy saving mode on a one-off basis (or temporarily).

The vibration sensor 206 can be disposed immediately outside the coils serving as the heater 203; however, the present disclosure is not limited thereto.

The vibration sensor 206 can be disposed to closely contact the bottom surface of the top plate 202 in order to closely sense the vibration information from the object supported by the top plate 202, but can also be disposed to have a slight distance from the bottom surface of the top plate 202 according to the sensitivity of the vibration sensor 206.

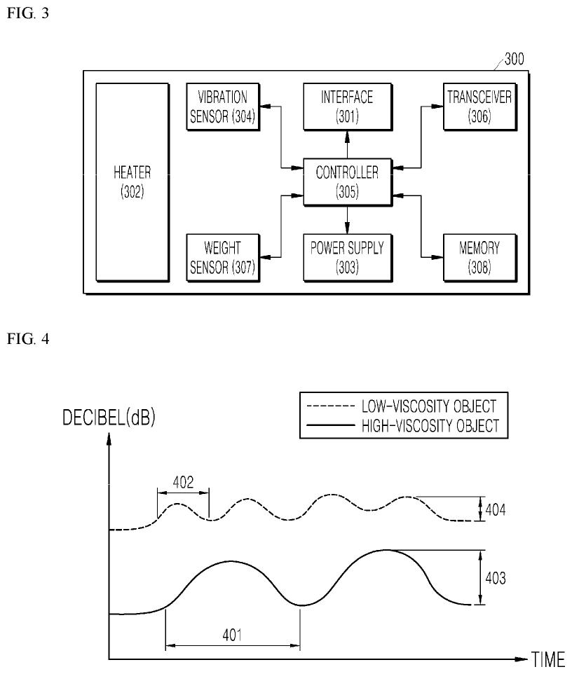

FIG. 3 is a block diagram showing the construction of an energy reduction heating apparatus according to another embodiment of the present disclosure.

Referring to FIG. 3, the energy reduction heating apparatus 300 can include an interface 301, a heater 302, a power supply 303, a vibration sensor 304, a controller 305, a transceiver 306, a weight sensor 307, and a memory 308.

The interface 301 can receive an operation command from a user. For example, the interface 301 can receive at least one command concerning on/off operation, heat intensity control, or an operation mode (an energy saving mode or a non-energy saving mode).

The heater 302 can include, for example, a plurality of coils, and can heat an object by using electric power supplied from the power supply 303.

Under control of the controller 305, the power supply 303 can supply electric power to the heater 302.

The vibration sensor 304 can be located at the lower part of the top plate 202. However, the present disclosure is not limited thereto. For example, the vibration sensor 304 can be located on the surface of the top plate 202. The vibration sensor 304 can sense vibration information at every set period. At this time, the vibration information can be a vibration pattern generated as the result of a change in state (for example, boiling state or temperature) of the object as the object disposed on top of the top plate 202 is heated by the heater 302, and can include at least one of a vibration period (or frequency), a vibration intensity (or the amplitude), or a vibration waveform.

The controller 305 can control the operation of various parts in the energy reduction heating apparatus 300, and can control the amount of electric power supplied to the heater 302, particularly based on the boiling state of the object (or the temperature of the object).

When the operation mode of the energy reduction heating apparatus 300 is an energy saving mode, the controller 305 can enable a function of controlling the amount of electric power supplied to the heater 302 based on the object (or the temperature of the object) estimated from the vibration information. Specifically, the controller 305 can estimate the boiling state of the object (or the temperature of the object) based on the vibration information sensed by the vibration sensor 304 at every set period, which can include a vibration pattern, and can control the amount of electric power supplied from the power supply 303 to the heater based on the estimated boiling state of the object (or the estimated temperature of the object).

At this time, the controller 305 can apply a vibration-based boiling state estimation algorithm to the vibration pattern included in the vibration information to easily estimate the boiling state (or the degree of boiling) of the object. The vibration-based boiling state estimation algorithm can be a neural network model trained to estimate the boiling state (or the degree of boiling) of an object (for example, food) based on the vibration information generated when the object is heated, and can be stored in the memory 308 in advance or can be received from the server.

In addition, the controller 305 can apply a vibration-based temperature estimation algorithm to the vibration pattern included in the vibration information to estimate the temperature of the object. The vibration-based temperature estimation algorithm can be a neural network model trained to estimate the temperature of an object based on the vibration information generated as the object is heated, and can be stored in the memory 308 in advance or can be received from the server.

As an example of controlling the amount of electric power supplied to the heater, if it is estimated that the object is in a boiling state based on the vibration information, the controller 305 can control the amount of electric power supplied to the heater 302 based on the vibration information sensed by the vibration sensor such that the number of coils that supply electric power, among the plurality of coils, is adjusted. Specifically, upon determining that the vibration intensity sensed by the vibration sensor 304 is higher than the vibration intensity corresponding to the boiling state, or that the vibration period sensed by the vibration sensor 304 is shorter than the vibration period corresponding to the boiling state, the controller 305 can control the amount of electric power supplied to the heater 302 by decreasing the number of coils supplying electric power by a predetermined amount. Conversely, upon determining that the vibration intensity sensed by the vibration sensor 304 is lower than the vibration intensity corresponding to the boiling state, or that the vibration period sensed by the vibration sensor 304 is longer than the vibration period corresponding to the boiling state, the controller 305 can control the amount of electric power supplied to the heater 302 by increasing the number of coils supplying electric power by a predetermined amount.

As another example of controlling the amount of electric power supplied to the heater 302, the controller 305 can estimate that the object is in a boiling state based on the vibration information, and can set the temperature of the object in the boiling state as the boiling point of the object. Here, the boiling point may not refer to a physical boiling point (where the boiling point of water is 100° C.) but a temperature at which the vibration intensity (for example, the vibration amplitude) becomes larger than a predetermined point. For example, the temperature at which bubbles start to form can be estimated as the boiling point, and temperatures at which much more bubbles are formed vigorously can be estimated as being higher than the boiling point.

The controller 305 can control the amount of electric power supplied to the heater 302 based on the boiling point such that the number of coils that supply electric power, among the plurality of coils, is adjusted. At this time, the controller 305 can compare the temperature of the object to the boiling point, and, upon determining that the temperature of the object is higher than the boiling point, can control the amount of electric power supplied to the heater 302 by decreasing the number of coils supplying electric power by a predetermined amount. Conversely, upon determining that the temperature of the object is lower than the boiling point, the controller 305 can control the amount of electric power supplied to the heater 302 by increasing the number of coils supplying electric power by a predetermined amount.

When decreasing or increasing the number of coils supplying electric power, the controller 305 can control relatively-outer coils (or outer coils) earlier than relatively-inner coils (or inner coils) (e.g., can supply electric power or interrupt the supply of electric power to the relatively-outer coils earlier than the relatively-inner coils) among a plurality of coils disposed, for example, in a circular form. The relatively-outer coils can be positioned further from a radial center than the relatively-inner coils.

That is, the controller 305 can decrease or increase the number of coils that supply electric power based on the result of comparison between the vibration intensity sensed by the vibration sensor as the object is continuously heated, and the vibration intensity corresponding to the boiling state of the object (or the result of comparison between the temperature of the object and the boiling point), whereby it is possible to reduce unnecessary consumption of electric power while maintaining the boiling state of the object.

When adjusting the number of coils that supply electric power, the controller 305 can identify the type of the object on the basis of the vibration pattern, and based on the identified type of the object, can vary an adjustment timepoint at which the number of coils supplying electric power among the plurality of coils in the heater is adjusted. Here, the type of the object can include, for example, a high-viscosity object whose viscosity is higher than a predetermined reference viscosity, and a low-viscosity object whose viscosity is lower than the predetermined reference viscosity.

When identifying the type of the object, the controller 305 can, for example, identify the type of the object on the basis of a similarity between the vibration pattern of the object and a predetermined vibration pattern (for example, a vibration pattern of a high-viscosity object or a vibration pattern of a low-viscosity object), or can estimate the viscosity of the object based on the vibration pattern, and can identify the type of the object based on the estimated viscosity. At this time, the controller 305 can estimate the viscosity by referring to a viscosity and vibration pattern table, or by using a neural network model trained to estimate viscosity from vibration patterns.

When identifying the type of the object using viscosity, the controller 305, for example the energy reduction heating apparatus, can confirm the viscosity of the object based on the vibration pattern, and if the confirmed viscosity is higher than a predetermined viscosity, can identify the type of the object as a high-viscosity object to be heated (for example, curry or rice porridge). Conversely, if the confirmed viscosity is lower than the predetermined viscosity, the energy reduction heating apparatus can identify the type of the object as a low-viscosity object (for example, water).

At this time, the controller 305 can define an adjustment delay time as a time period between a determination timepoint at which the determination is made that the vibration intensity sensed by the vibration sensor 304 is stronger than the vibration intensity corresponding to the boiling state of the object. Alternatively, the controller 305 can define the adjustment delay time as a time period between the adjustment timepoint and a determination timepoint at which the determination is made that the temperature of the object has become higher than the boiling point of the object. Since the more viscous an object, the more slowly the temperature of the object is to increase or decrease, the controller 305 can set such that a first adjustment delay time (for example, 3 seconds), which is for a high-viscosity object, is longer than a second adjustment delay time (for example, 1 second) for a low-viscosity object.

As such, if a low-viscosity object, such as water, is boiling, the controller 305 can adjust the number of coils supplying electric power within 1 second, thereby rapidly adjusting the amount of heat applied to the water. Conversely, if a low-viscosity object, such as curry, is boiling, the controller 305 can take, for example, 3 seconds to adjust the number of coils supplying electric power, thereby adjusting the amount of heat applied to the curry more slowly than is to water.

The controller 305 can control the amount of electric power supplied to the heater 302 based on the temperature of the object, thereby conserving energy. In the case in which an elapsed time from the timepoint at which boiling starts exceeds a predetermined reference time, the controller 305 can provide a notification about the heated state of the object to the user so that the user can recognize the heated state of the object (e.g., the fact that the object has been continuously heated for more than the predetermined reference time).

Conversely, in the case in which the operation mode of the energy reduction heating apparatus 300 is a non-energy saving mode, the controller 305 can disable the function of controlling the amount of electric power supplied to the heater 302, and upon determining that a predetermined condition is satisfied, can provide a warning notification about the object so that the object can be prevented from turning into an undesirable state against the user's intention.

For example, the controller 305 can confirm the viscosity (or the type) of the object based on the vibration pattern in the vibration information and, as the difference between a reference period (or a reference frequency) set in advance based on the confirmed viscosity of the object and the vibration period (or the frequency) in the vibration information exceeds a predetermined time (or a predetermined value), the controller 305 can provide a warning notification about the object. At this time, the controller 305 can set the reference period to be longer as the viscosity of the object is higher. For example, the controller 305 can set the reference period for a high-viscosity object with a relatively high viscosity to be longer than the reference period for a low-viscosity object with a relatively low viscosity.

That is, as the vibration period in the vibration information sensed by the vibration sensor 304 exceeds, over a predetermined time, the reference period based on the type of the object, the controller 305 can determine that the object is being heated for too long that it is likely to overcook, and then provide a warning notification about the object through an internal component or can provide the warning notification to a user terminal. For example, the controller 305 can output a beep sound through a built-in beep sound speaker, or can transmit a warning notification message about the object to the user terminal. At this time, the controller 305 can include the time duration for which the object has been heated (or boiled) in the warning notification message being transmitted. For example, the controller 305 can transmit a warning notification message such as “Your food has been boiling for 10 minutes and can be burning. Please check.” to the user terminal.

Also, if the frequency in the vibration information sensed by the vibration sensor 304 decreases at a predetermined rate or faster, the controller 305 can determine that the object is being heated too fast or too abruptly and provide a warning notification about the object.

When providing the warning notification about the object, the controller 305 can provide the warning notification about the object only when the type of the object is a high-viscosity object.

The transceiver 306 can receive images of the object captured at every set period by a camera located within a predetermined distance from the object. Here, the camera can be mounted to a kitchen range hood at an angle at which the camera is capable of capturing images of the object. The controller 305 estimates the boiling state of the object (or the temperature of the object) based on the vibration information sensed by the vibration sensor 304. However, the method of estimating the boiling state of the object (or the temperature of the object) is not limited thereto. For example, upon receiving the captured images of the object through the transceiver 306, the controller 305 can use the images in addition to the vibration information to estimate the boiling state of the object (or the temperature of the object), and can easily estimate the boiling state of the object (or the temperature of the object) by applying an image-based boiling state estimation algorithm (or an image-based temperature estimation algorithm) to the images.

The image-based boiling state estimation algorithm (or the image-based temperature estimation algorithm) can be a neural network model trained to estimate a boiling state of an object (or the temperature of the object) based on changes observable in the captured images as the object is being heated, for example, changes in terms of the amount of activity in the object being heated, the form of the object, and the amount of steam generated. In addition, the image-based boiling state estimation algorithm can be stored in the memory 308 in advance or can be received from a server, in the same manner as in the vibration-based boiling state estimation algorithm (or the vibration-based temperature estimation algorithm)

As a result, the controller 305 can estimate the boiling state of the object by using the vibration information sensed by the vibration sensor 304 and the images captured by the camera.

The controller 305 can estimate the final boiling state of the object (or the final temperature of the object) by using the boiling state of the object (or the temperature of the object) estimated based on the vibration information and the boiling state of the object (or the temperature of the object) estimated based on the images.

For example, if temperatures of the object are estimated from the vibration information and the images, upon determining that the difference between the estimated temperatures of the object is less than a predetermined temperature, the controller 305 can calculate an average of the temperatures of the object and estimate the average as the final temperature of the object. At this time, upon determining that the difference between the estimated temperatures of the object is greater than the predetermined temperature, the controller 305 can estimate the temperature of the object estimated based on the vibration information as the final temperature of the object. That is, the controller 305 can adjust the temperature of the object estimated based on the vibration information in consideration of the temperature of the object estimated based on the images. If the difference between the estimated temperatures of the object is greater than the predetermined temperature, however, the temperature of the object estimated based on the vibration information can be more reliable.

The weight sensor 307 can acquire information about the weight of the object supported by the top plate of the energy reduction heating apparatus 300.

Since the amount of heat necessary for the object to reach a boiling state (or for the temperature of the object to reach a boiling point) varies depending on the weight of the object, the controller 305 can estimate the boiling state of the object (or the temperature of the object) by further considering the weight of the object acquired by the weight sensor 307 in addition to the vibration information sensed by the vibration sensor 304.

The memory 308 can store the vibration-based boiling state estimation algorithm (or the vibration-based temperature estimation algorithm). In addition, the memory 308 can further store the image-based boiling state estimation algorithm (or the image-based temperature estimation algorithm).

The memory 308 can perform the function of temporarily or permanently storing data processed by the controller 305. Herein, the memory 308 can include magnetic storage media or flash storage media, but the scope of the present disclosure is not limited thereto. The memory 308 can include an internal memory and/or an external memory and can include a volatile memory such as a DRAM, a SRAM or a SDRAM, and a non-volatile memory such as one-time programmable ROM (OTPROM), a PROM, an EPROM, an EEPROM, a mask ROM, a flash ROM, a NAND flash memory or a NOR flash memory, a flash drive such as an SSD, a compact flash (CF) card, an SD card, a Micro-SD card, a Mini-SD card, an XD card or memory stick, or a storage device such as a HDD.

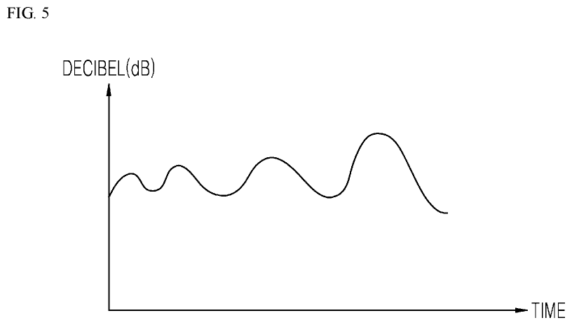

FIGS. 4 and 5 are diagrams illustrating vibration information sensed by the energy reduction heating apparatus according to an embodiment of the present disclosure.

Referring to FIG. 4, the energy reduction heating apparatus can heat, through the top plate disposed at an upper part of a heater, an object placed on top of the top plate, by using heat generated from the heater in accordance with the electric power being supplied to the heater. Here, the object can be placed in a pot, and bubbles can be formed as the object is heated.

As the pot vibrates due to formation of the bubbles, the energy reduction heating apparatus can sense vibration information about the vibration through the vibration sensor disposed below the top plate. In addition, the energy reduction heating apparatus can further sense vibration information about vibrations generated between the vibrating pot and the top plate through the vibration sensor. Here, the vibration information can refer to a vibration pattern including at least one of a vibration period (or frequency), a vibration amplitude, or a vibration waveform of the vibrations.

The energy reduction heating apparatus can identify the type of the object based on the vibration pattern. For example, the energy reduction heating apparatus can confirm the viscosity of the object based on the vibration pattern and, if the confirmed viscosity is higher than a predetermined viscosity, can identify the type of the object as a high-viscosity object (for example, curry or porridge). Conversely, if the confirmed viscosity is lower than the predetermined viscosity, the energy reduction heating apparatus can identify the type of the object as a low-viscosity object (for example, water).

The vibration period 401 in the vibration information identified as a high-viscosity object can be longer than the vibration period 402 in the vibration information identified as a low-viscosity object, and the vibration amplitude 403 in the vibration information identified as the high-viscosity object can be greater than the amplitude of vibration 404 in the vibration information identified as the low-viscosity object.

Also, in the case of a high-viscosity object (or a liquid mixture, such as sugar water), as shown in FIG. 5, as the heating time increases, the period of vibration increases, which decreases the vibration frequency, and as a result, the amplitude of vibration (decibel (dB)) can decrease.

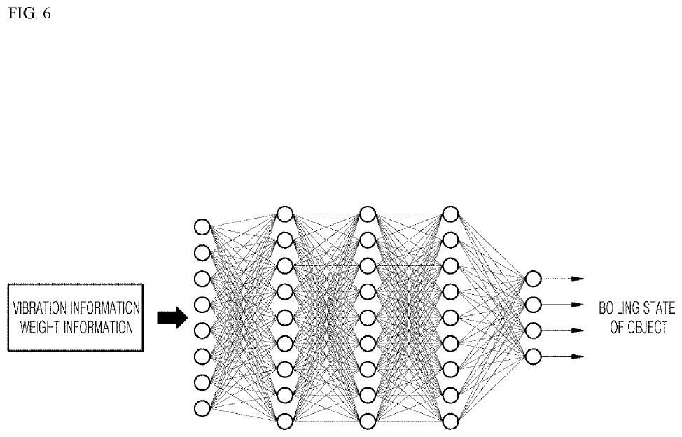

FIG. 6 is a diagram illustrating a neural network model for estimating the boiling state of the object in the energy reduction heating apparatus according to an embodiment of the present disclosure.

Referring to FIG. 6, the energy reduction heating apparatus can use a vibration-based boiling state estimation algorithm (or a vibration-based temperature estimation algorithm) to estimate the boiling state of the object (or the temperature of the object). Here, the vibration-based boiling state estimation algorithm (or the vibration-based temperature estimation algorithm) can be a deep neural network model trained through machine learning of artificial intelligence to estimate the boiling state of the object (or the temperature of the object) based on vibration information (a vibration pattern) generated as the object (for example, food) is heated.

Artificial intelligence (AI) is an area of computer engineering science and information technology that studies methods to make computers mimic intelligent human behaviors such as reasoning, learning, and self-improving.

In addition, artificial intelligence does not exist on its own, but is rather directly or indirectly related to a number of other fields in computer science. In recent years, there have been numerous attempts to introduce an element of the artificial intelligence into various fields of information technology to address issues in the respective fields.

Machine learning is an area of artificial intelligence that includes the field of study that gives computers the capability to learn without being explicitly programmed.

Specifically, machine learning can be a technology for researching and constructing a system for learning, predicting, and improving its own performance based on empirical data and an algorithm for the same. Machine learning algorithms, rather than only executing rigidly set static program commands, can be used to take an approach that builds models for deriving predictions and decisions from inputted data.

Numerous machine learning algorithms have been developed for data classification in machine learning. Representative examples of such machine learning algorithms for data classification include a decision tree, a Bayesian network, a support vector machine (SVM), an artificial neural network (ANN), and so forth.

A decision tree refers to an analysis method that uses a tree-like graph or model of decision rules to perform classification and prediction

Bayesian network can include a model that represents the probabilistic relationship (conditional independence) among a set of variables. Bayesian network can be appropriate for data mining via unsupervised learning.

SVM can include a supervised learning model for pattern detection and data analysis, heavily used in classification and regression analysis.

An ANN is a data processing system modelled after the mechanism of biological neurons and interneuron connections, in which a number of neurons, referred to as nodes or processing elements, are interconnected in layers.

ANNs are models used in machine learning and can include statistical learning algorithms conceived from biological neural networks (particularly of the brain in the central nervous system of an animal) in machine learning and cognitive science.

ANNs can refer generally to models that have artificial neurons (nodes) forming a network through synaptic interconnections, and acquires problem-solving capability as the strengths of synaptic interconnections are adjusted throughout training.

The terms “artificial neural network” and “neural network” can be used interchangeably herein.

An ANN can include a number of layers, each including a number of neurons. Furthermore, the ANN can include synapses that connect the neurons to one another.

An ANN can be defined by the following three factors: (1) a connection pattern between neurons on different layers; (2) a learning process that updates synaptic weights; and (3) an activation function generating an output value from a weighted sum of inputs received from a lower layer.

ANNs include, but are not limited to, network models such as a deep neural network (DNN), a recurrent neural network (RNN), a bidirectional recurrent deep neural network (BRDNN), a multilayer perception (MLP), and a convolutional neural network (CNN).

An ANN can be classified as a single-layer neural network or a multi-layer neural network, based on the number of layers therein.

A general single-layer neural network is composed of an input layer and an output layer.

In addition, a general multi-layer neural network is composed of an input layer, one or more hidden layers, and an output layer.

The input layer receives data from an external source, and the number of neurons in the input layer is identical to the number of input variables. The hidden layer is located between the input layer and the output layer, and receives signals from the input layer, extracts features, and feeds the extracted features to the output layer. The output layer receives a signal from the hidden layer and outputs an output value based on the received signal. Input signals between the neurons are summed together after being multiplied by corresponding connection strengths (synaptic weights), and if this sum exceeds a threshold value of a corresponding neuron, the neuron can be activated and output an output value obtained through an activation function.

A deep neural network with a plurality of hidden layers between the input layer and the output layer can be the most representative type of artificial neural network which enables deep learning, which is one machine learning technique.

An ANN can be trained using training data. Here, the training can refer to the process of determining parameters of the ANN by using the training data, to perform tasks such as classification, regression analysis, and clustering of inputted data. Such parameters of the ANN can include synaptic weights and biases applied to neurons.

An ANN trained using training data can classify or cluster inputted data according to a pattern within the inputted data.

Throughout the present specification, an ANN trained using training data can be referred to as a trained model.

Hereinbelow, learning paradigms of an ANN will be described in detail.

Learning paradigms, in which an ANN operates, can be classified into supervised learning, unsupervised learning, semi-supervised learning, and reinforcement learning.

Supervised learning is a machine learning method that derives a single function from the training data.

Among the functions that can be thus derived, a function that outputs a continuous range of values can be referred to as a regressor, and a function that predicts and outputs the class of an input vector can be referred to as a classifier.

In supervised learning, an ANN can be trained with training data that has been given a label.

Here, the label can refer to a target answer (or a result value) to be guessed by the ANN when the training data is inputted to the ANN.

Throughout the present specification, the target answer (or a result value) to be guessed by the ANN when the training data is inputted can be referred to as a label or labeling data.

Throughout the present specification, assigning one or more labels to training data in order to train an ANN can be referred to as labeling the training data with labeling data.

Training data and labels corresponding to the training data together can form a single training set, and as such, they can be input to an ANN as a training set.

The training data can exhibit a number of features, and the training data being labeled with the labels can be interpreted as the features exhibited by the training data being labeled with the labels. In this case, the training data can represent a feature of an input object as a vector.

Using training data and labeling data together, the ANN can derive a correlation function between the training data and the labeling data. Then, through evaluation of the function derived from the ANN, a parameter of the ANN can be determined (optimized).

Unsupervised learning is a machine learning method that learns from training data that has not been given a label.

More specifically, unsupervised learning can be a training scheme that trains an ANN to discover a pattern within given training data and perform classification by using the discovered pattern, rather than by using a correlation between given training data and labels corresponding to the given training data.

Examples of unsupervised learning include, but are not limited to, clustering and independent component analysis.

Examples of ANNs using unsupervised learning include, but are not limited to, a generative adversarial network (GAN) and an autoencoder (AE).

GAN is a machine learning method in which two different artificial intelligences, a generator and a discriminator, improve performance through competing with each other.

The generator can be a model generating new data that generates new data based on true data.

The discriminator can be a model recognizing patterns in data that determines whether inputted data is from the true data or from the new data generated by the generator.

Furthermore, the generator can receive and learn from data that has failed to fool the discriminator, while the discriminator can receive and learn from data that has succeeded in fooling the discriminator. Accordingly, the generator can evolve so as to fool the discriminator as effectively as possible, while the discriminator evolves so as to distinguish, as effectively as possible, between the true data and the data generated by the generator.

An auto-encoder (AE) is a neural network which aims to reconstruct its input as output.

More specifically, an AE can include an input layer, at least one hidden layer, and an output layer.

Since the number of nodes in the hidden layer is smaller than the number of nodes in the input layer, the dimensionality of data is reduced, thus leading to data compression or encoding.

Furthermore, the data outputted from the hidden layer can be inputted to the output layer. Given that the number of nodes in the output layer is greater than the number of nodes in the hidden layer, the dimensionality of the data increases, thus leading to data decompression or decoding.

Furthermore, in the AE, the inputted data is represented as hidden layer data as interneuron connection strengths are adjusted through training. The fact that when representing information, the hidden layer is able to reconstruct the inputted data as output by using fewer neurons than the input layer can indicate that the hidden layer has discovered a hidden pattern in the inputted data and is using the discovered hidden pattern to represent the information.

Semi-supervised learning is machine learning method that makes use of both labeled training data and unlabeled training data.

One semi-supervised learning technique involves inferring the label of unlabeled training data, and then using this inferring label for learning. This technique can be used advantageously when the cost associated with the labeling process is high.

Reinforcement learning can be based on a theory that given the condition under which a reinforcement learning agent can determine what action to choose at each time instance, the agent can find an optimal path to a solution solely based on experience without reference to data.

Reinforcement Learning can be mainly performed by a Markov Decision Process (MDP).

Markov decision process consists of four stages: first, an agent is given a condition containing information required for performing a next action; second, how the agent behaves in the condition is defined; third, which actions the agent should choose to get rewards and which actions to choose to get penalties are defined; and fourth, the agent iterates until future reward is maximized, thereby deriving an optimal policy.

An ANN is characterized by features of its model, the features including an activation function, a loss function or cost function, a learning algorithm, an optimization algorithm, and so forth. Also, the hyperparameters are set before learning, and model parameters can be set through learning to specify the architecture of the ANN.

For instance, the structure of an ANN can be determined by a number of factors, including the number of hidden layers, the number of hidden nodes included in each hidden layer, input feature vectors, target feature vectors, and so forth.

Hyperparameters can include various parameters which need to be initially set for learning, much like the initial values of model parameters. Also, the model parameters can include various parameters sought to be determined through learning.

For instance, the hyperparameters can include initial values of weights and biases between nodes, mini-batch size, iteration number, learning rate, and so forth. Furthermore, the model parameters can include a weight between nodes, a bias between nodes, and so forth.

Loss function can be used as an index (reference) in determining an optimal model parameter during the learning process of an ANN. Learning in the ANN involves a process of adjusting model parameters so as to reduce the loss function, and the purpose of learning can be to determine the model parameters that minimize the loss function.

Loss functions typically use means squared error (MSE) or cross entropy error (CEE), but the present disclosure is not limited thereto.

Cross-entropy error can be used when a true label is one-hot encoded. One-hot encoding can include an encoding method in which among given neurons, only those corresponding to a target answer are given 1 as a true label value, while those neurons that do not correspond to the target answer are given 0 as a true label value.

In machine learning or deep learning, learning optimization algorithms can be deployed to minimize a cost function, and examples of such learning optimization algorithms include gradient descent (GD), stochastic gradient descent (SGD), momentum, Nesterov accelerate gradient (NAG), Adagrad, AdaDelta, RMSProp, Adam, and Nadam.

GD includes a method that adjusts model parameters in a direction that decreases the output of a cost function by using a current slope of the cost function.

The direction in which the model parameters are to be adjusted can be referred to as a step direction, and a size by which the model parameters are to be adjusted can be referred to as a step size.

Here, the step size can mean a learning rate.

GD obtains a slope of the cost function through use of partial differential equations, using each of model parameters, and updates the model parameters by adjusting the model parameters by a learning rate in the direction of the slope.

SGD can include a method that separates the training dataset into mini batches, and by performing gradient descent for each of these mini batches, increases the frequency of gradient descent.

Adagrad, AdaDelta and RMSProp can include methods that increase optimization accuracy in SGD by adjusting the step size. In SGD, a momentum and Nesterov accelerate gradient (NAG) are methods for increasing optimization accuracy by adjusting a step direction. Adam can include a method that combines momentum and RMSProp and increases optimization accuracy in SGD by adjusting the step size and step direction. Nadam can include a method that combines NAG and RMSProp and increases optimization accuracy by adjusting the step size and step direction.

Learning rate and accuracy of an ANN rely not only on the structure and learning optimization algorithms of the ANN but also on the hyperparameters thereof. Therefore, in order to obtain a good learning model, it is important to choose a proper structure and learning algorithms for the ANN, but also to choose proper hyperparameters.

In general, the ANN is first trained by experimentally setting hyperparameters to various values, and based on the results of training, the hyperparameters can be set to optimal values that provide a stable learning rate and accuracy.

The boiling state of the object (or the temperature of the object) can be more sophisticatedly estimated using the above methods.

While there can be various methods for generating a deep neural network model for use in an embodiment of the present disclosure, in the case of supervised learning, the following training process can be performed as a preliminary work.

After an apparatus capable of directly measuring the boiling state of the object (or the temperature of the object) in the pot and a microphone capable of collecting sound generated from the pot on the top plate of the energy reduction heating apparatus (for example, an electric range) are installed, it is possible to record the boiling state of the object (or the temperature of the object) and vibration generated at a relevant temperature while changing the kind, weight, and size of the pot, and the kind, weight, and size of the object in the pot.

Recorded data can be vibration data labeled with the boiling state (or the temperature), and a deep neural network model can be trained using the labeled data such that the deep neural network model can estimate the boiling state of the object (or the temperature of the object) based on vibration generated from the pot on the top plate of the energy reduction heating apparatus.

The deep neural network model generated through the above preliminary work can be embedded into the memory of the energy reduction heating apparatus or can be stored in a server with which the energy reduction heating apparatus communicates, and can be used to estimate the boiling state of the object (or the temperature of the object) based on vibration information received from the vibration sensor of the energy reduction heating apparatus during actual use of the energy reduction heating apparatus.

Vibration information (for example, a vibration pattern including at least one of a vibration period, a vibration intensity, or a vibration waveform) collected from the object that is heated by the energy reduction heating apparatus and weight information sensed by the weight sensor can be input to the deep neural network model trained as described above, whereby the result of estimation about the temperature of the object can be outputted.

Input information, in addition to the information shown in FIG. 6, can include various kinds of information such as the material of the pot, the shape of the pot, and the kind of the object and in this case, it is natural that a deep neural network model suitable therefor can be trained and used.

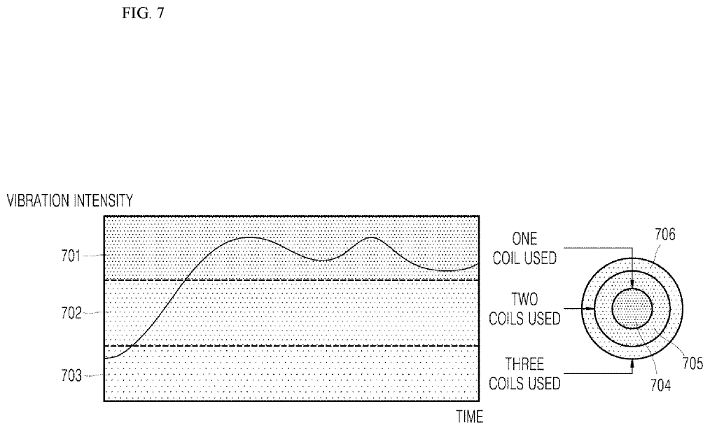

FIG. 7 is a diagram illustrating an example in which the energy reduction heating apparatus according to an embodiment of the present disclosure controls the amount of electric power supplied to the heater based on a change in state of the object.

Referring to FIG. 7, the energy reduction heating apparatus can estimate that the object is in a boiling state based on vibration information sensed by the vibration sensor at every set period as the object is heated, and can adjust the number of coils supplying electric power, among the plurality of coils, based on the vibration information sensed by the vibration sensor.

For example, upon determining that the intensity of vibration sensed by the vibration sensor is higher than the vibration intensity corresponding to the boiling state, or that the vibration period sensed by the vibration sensor is shorter than the vibration period corresponding to the boiling state, the energy reduction heating apparatus can decrease the number of coils supplying electric power by a predetermined amount. Conversely, upon determining that the vibration intensity sensed by the vibration sensor is lower than the vibration intensity corresponding to the boiling state or that the vibration period sensed by the vibration sensor is longer than the vibration period corresponding to the boiling state, the energy reduction heating apparatus can increase the number of coils supplying electric power by a predetermined amount.

As another example, the energy reduction heating apparatus can estimate that the object is in a boiling state, based on vibration information sensed by the vibration sensor at every set period as the object is heated, and can set the temperature of the object in the boiling state as the boiling point of the object.

Subsequently, the energy reduction heating apparatus can control the amount of electric power supplied to the heater based on the boiling point by adjusting the number of coils supplying electric power among the plurality of coils. At this time, the energy reduction heating apparatus can compare the temperature of the object estimated from the vibration information to the boiling point, and upon determining that the temperature of the object is higher or lower than the boiling point, can increase or decrease the number of coils supplying electric power by a predetermined amount. Consequently, by decreasing or increasing the amount of electric power supplied to the heater based on the temperature of the object, the energy reduction heating apparatus can be able to supply the minimum amount of energy required while maintaining the boiling state of the object.

As another example, the energy reduction heating apparatus can set a plurality of temperature sections with respect to the boiling point, and can control the amount of electric power supplied to the heater based on the temperature section that the temperature of the object belongs to, and thus, the energy reduction heating apparatus can be able to flexibly respond to a change in temperature of the object when controlling the amount of electric power supplied to the heater.

For example, the energy reduction heating apparatus can set a plurality of vibration intensity sections (or a plurality of temperature regions) into three sections, e.g., a first section 701, a second section 702, and a third section 703, based on the vibration intensity (or the boiling point) corresponding to the boiling state of the object (for example, the timepoint at which the object starts to boil). At this time, the energy reduction heating apparatus can set a second section 702 including the vibration intensity (or the boiling point) of the boiling state, a first section 701 having a higher vibration intensity (or temperature of the object) than the second section 702, and a third section 703 having a lower vibration intensity (or temperature of the object) than the second section 702. In addition, the energy reduction heating apparatus can adjust the size of each section (the range of vibration intensity (or the temperature of the object)) based on a predetermined condition (for example, the vibration intensity or the temperature of the object).

Specifically, for example, when electric power is being supplied to three coils in the heater at an initial stage, as the section exhibiting the vibration intensity (or the temperature of the object) estimated from the vibration information sensed by the vibration sensor changes from the third section 703 to the second section 702, the energy reduction heating apparatus can reduce the number of coils in the heater that supply electric power from three to two. As a result, the energy reduction heating apparatus can cause electric power to be supplied only to a first coil 704 and a second coil 705.

Also, if the section exhibiting the vibration intensity (or the temperature of the object) estimated from the vibration information sensed by the vibration sensor changes from the second section 702 to the first section 701 while electric power is being continuously supplied to two coils in the heater, the energy reduction heating apparatus can reduce the number of coils supplying electric power in the heater from two to one. As a result, the energy reduction heating apparatus can cause electric power to be supplied only to the first coil 704.

Conversely, if the section exhibiting the vibration intensity (or the temperature of the object) estimated from the vibration information sensed by the vibration sensor changes from the first section 701 to the second section 702 while electric power is being continuously supplied to one coil in the heater, the energy reduction heating apparatus can reduce the number of coils supplying electric power in the heater from one to two. As a result, the energy reduction heating apparatus can cause electric power to be supplied to both the first coil 704 and the second coil 705.

Consequently, the energy reduction heating apparatus can reduce unnecessary consumption of energy while maintaining the boiling state (or a predetermined temperature range) of the object by adjusting the number of coils supplying electric power among the plurality of coils in the heater, based on the vibration intensity (or the temperature of the object).

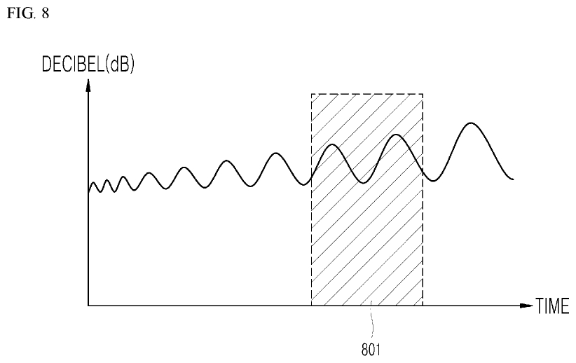

FIG. 8 is a diagram illustrating an example in which the energy reduction heating apparatus according to the embodiment of the present disclosure provides a warning notification when the state of the object is changed.

Referring to FIG. 8, when the energy reduction heating apparatus is operating in a non-energy saving mode, the energy reduction heating apparatus can determine that the user intends to continuously heat the object, and can deactivate the control over the amount of electric power supplied to the heater on the basis of the temperature of the object.

The energy reduction heating apparatus can monitor the state of the object based on vibration information sensed by the vibration sensor. Upon estimating that the state of the object, due to overextended heating period, will be turning into an undesirable against the user's intention as a result of the monitoring, the energy reduction heating apparatus can provide a warning notification about the object. For example, if the vibration period in the vibration information sensed by the vibration sensor becomes longer than a predetermined reference period over a predetermined time 801, the energy reduction heating apparatus can determine that the object is being heated for too long that it is likely to overcook, and then provide a warning notification about the object through an internal component or can provide the warning notification to the user terminal. At this time, the energy reduction heating apparatus can further confirm the vibration intensity (for example, the amplitude) in addition to the vibration period. That is, if the vibration period in the vibration information becomes longer than the predetermined reference period over the predetermined time, and if the vibration intensity in the vibration information becomes higher than a predetermined reference intensity over the predetermined time, the energy reduction heating apparatus can determine that there is a high chance that the object will overcook, and provide a warning notification about the object.

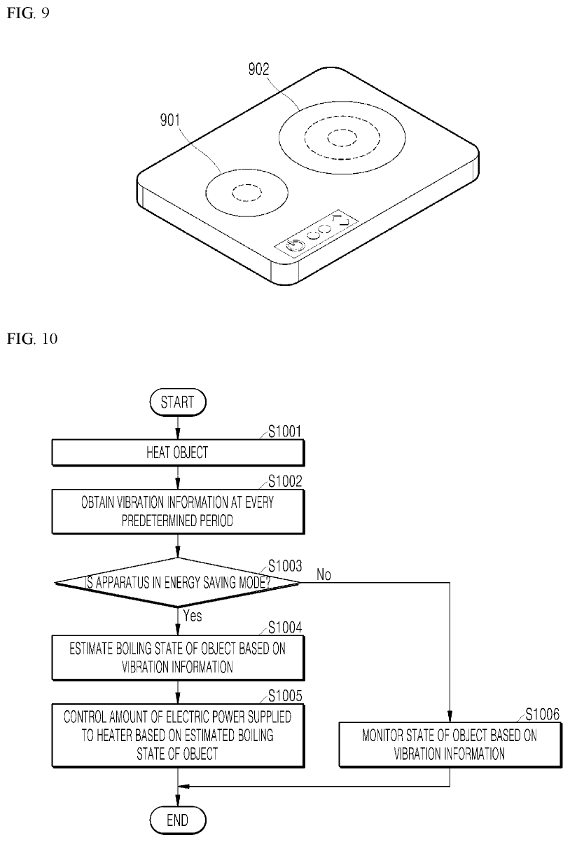

FIG. 9 is a diagram illustrating an example in which an energy reduction heating apparatus according to another embodiment of the present disclosure controls the amount of electric power supplied when heating a plurality of objects.

Referring to FIG. 9, the energy reduction heating apparatus can include a plurality of heaters respectively configured to heat a plurality of objects and a plurality of vibration sensors respectively configured to sense vibrations generated from each of the plurality of objects as the plurality of objects are heated.

At this time, the respective heaters can have different numbers of coils included therein. For example, a first heater 901 can include two coils, and a second heater 902, which is larger than the first heater, can include three coils.

In addition, each of the plurality of vibration sensors can be disposed within a predetermined distance in relation to the plurality of heaters. That is, a first vibration sensor can be disposed within a predetermined distance from the first heater 901, and a second vibration sensor can be disposed within a predetermined distance from the second heater 902. Meanwhile, the first and second vibration sensors can be disposed as far apart as possible from each other.

As the plurality of objects are heated, vibration information obtained by each of the plurality of vibration sensors can include, not only the vibration information generated by a corresponding heater due to changes in the state (for example, changes in viscosity or temperature) of the object heated by the corresponding heater, but also the vibration information generated by another heater due to changes in the state of another object. Therefore, the energy reduction heating apparatus can filter the vibration information sensed by the vibration sensors based on a predetermined filtering criterion (for example, removing vibration information less than a set value based on a distance between the vibration sensors, or removing vibration information having a relatively small size), and can estimate the boiling state of the object (or the temperature of the object) based on the filtered vibration information.

For example, vibration information sensed by the first vibration sensor can include, not only first vibration information generated due to changes in the state of a first object being heated by the first heater 901, but also, second vibration information generated due to changes in the state of a second object being heated by the second heater 902.

As such, the energy reduction heating apparatus can remove, from the vibration information sensed by the first vibration sensor, vibration information less than a set value (for example, the second vibration information generated due to a change in state of the second object), e.g., a noise based on the first vibration sensor. The energy reduction heating apparatus can estimate the boiling state of the first object (or the temperature of the first object to be heated) based on the vibration information with the noise removed therefrom, and can control the amount of electric power supplied to the heater based on the estimated boiling state of the first object (or the estimated temperature of the first object).

In addition, the energy reduction heating apparatus can remove, from the vibration information sensed by the second vibration sensor, vibration information less than the set value (for example, the first vibration information generated due to changes in the state of the first object), e.g., a noise based on the second vibration sensor. The energy reduction heating apparatus can estimate the boiling state of the second object (or the temperature of the second object) based on the vibration information with the noise removed therefrom, and can control the amount of electric power supplied to the heater based on the estimated boiling state of the second object (or the estimated temperature of the second object).

The set value can be set based on the distance between the first vibration sensor and the second vibration sensor.

FIG. 10 is a flowchart showing an operation method of the energy reduction heating apparatus according to an embodiment of the present disclosure. Here, the energy reduction heating apparatus can store, in a memory in advance, a vibration-based boiling state estimation algorithm (or a vibration-based temperature estimation algorithm), which is a neural network model trained to estimate the boiling state of an object being heated (or the temperature of the object) based on vibration information generated as the object is heated. In addition, the energy reduction heating apparatus can also store in advance, in the memory, an image-based boiling state estimation algorithm (or an image-based temperature estimation algorithm), which is a neural network model trained to estimate the boiling state of the object (or the temperature of the object) based on changes observable in the captured images of the object as the object is heated, in terms of the amount of activity in the object, changes in the form of the object.

Referring to FIG. 10, in step 51001, upon receiving an operation ON command from a user through an interface, a heater in the energy reduction heating apparatus can heat an object disposed on a top plate of the energy reduction heating apparatus. The heater can include a plurality of coils.

In step S1002, a vibration sensor in the energy reduction heating apparatus can sense vibration information at every set period. Here, the vibration information can include a vibration pattern which includes at least one of a vibration period, a vibration intensity, or a vibration waveform.

In step S1003, a controller in the energy reduction heating apparatus can confirm the operation mode of the energy reduction heating apparatus and, upon confirming that the operation mode is an energy saving mode, can estimate the boiling state of the object (or the temperature of the object) based on the vibration information sensed in step S1004. At this time, the controller in the energy reduction heating apparatus can estimate the boiling state of the object (or the temperature of the object) by applying the vibration-based boiling state estimation algorithm (or the vibration-based temperature estimation algorithm) in the memory to the vibration information (e.g., the vibration pattern).

In addition, the controller in the energy reduction heating apparatus can estimate the boiling state of the object (or the temperature of the object) by using images captured by a camera along with the vibration information sensed by the vibration sensor.

Upon receiving images of the object captured at every set period from the camera located within a predetermined distance from the object through a transceiver, the controller in the energy reduction heating apparatus can estimate the boiling state of the object (or the temperature of the object) based on the images in addition to the vibration information sensed by the vibration sensor. At this time, the controller in the energy reduction heating apparatus can estimate the boiling state of the object (or the temperature of the object) by applying the image-based boiling state estimation algorithm (or the image-based temperature estimation algorithm) in the memory to the images.

In step S1005, the controller in the energy reduction heating apparatus can control the amount of electric power supplied to the heater based on the estimated boiling state of the object (or the estimated temperature of the object).

At this time, upon estimating that the object is in a boiling state based on the vibration information, the controller in the energy reduction heating apparatus can control the amount of electric power supplied to the heater based on the vibration information sensed by the vibration sensor by adjusting the number of coils supplying electric power among the plurality of coils.

Specifically, upon determining that the vibration intensity sensed by the vibration sensor is higher than the intensity of vibration corresponding to the boiling state, or that the vibration period sensed by the vibration sensor is shorter than the vibration period corresponding to the boiling state, the controller in the energy reduction heating apparatus can control the amount of electric power supplied to the heater by decreasing the number of coils that supply electric power by a predetermined amount. Conversely, upon determining that the intensity of vibration sensed by the vibration sensor is lower than the intensity of vibration corresponding to the boiling state or that the vibration period sensed by the vibration sensor is longer than the vibration period corresponding to the boiling state, the controller in the energy reduction heating apparatus can control the amount of electric power supplied to the heater by increasing the number of coils supplying electric power by a predetermined amount.

In addition, the controller in the energy reduction heating apparatus can estimate that the object is in a boiling state based on the vibration information, and can set the temperature of the object in the boiling state as the boiling point of the object. Also, the controller in the energy reduction heating apparatus can control the amount of electric power supplied to the heater based on the boiling point by adjusting the number of coils supplying electric power among the plurality of coils. At this time, upon determining that the temperature of the object is higher than the boiling point, the controller in the energy reduction heating apparatus can control the amount of electric power supplied to the heater by decreasing the number of coils that supply electric power by a predetermined amount. Conversely, upon determining that the temperature of the object is lower than the boiling point, the controller in the energy reduction heating apparatus can control the amount of electric power supplied to the heater by increasing the number of coils supplying electric power by a predetermined amount.

Meanwhile, the controller in the energy reduction heating apparatus can identify the type of the object based on the vibration pattern in the vibration information, and based on the identified type of the object, set an adjustment timepoint at which the number of coils supplying electric power is adjusted in the plurality of coils in the heater. The type of the object can include, for example, a high-viscosity object having a relatively high viscosity and a low-viscosity object having a relatively low viscosity.

The controller in the energy reduction heating apparatus can define an adjustment delay time as a time period between the adjustment timepoint and a determination timepoint at which the vibration intensity sensed by the vibration sensor is determined to be stronger than the vibration intensity corresponding to the boiling state of the object. The controller can also define the adjustment delay time as a time period between the adjustment timepoint and a determination timepoint at which the temperature of the object is determined to be higher than the boiling point of the object. When a first adjustment delay time is an adjustment delay time when the object being heated is a high-viscosity object, and a second adjustment delay time is an adjustment delay time when the object being heated is a low-viscosity object, the controller in the energy reduction heating apparatus can set the first adjustment delay time to be longer than the second adjustment delay time.

In step S1003, upon confirming that the energy reduction heating apparatus is operating not in the energy-saving mode (e.g., a non-energy saving mode), the controller in the energy reduction heating apparatus can monitor the state of the object based on the vibration information sensed in step S1006. At this time, the controller in the energy reduction heating apparatus can confirm the viscosity of the object based on the vibration pattern in the vibration information. When the difference between a reference period set in advance based on the confirmed viscosity of the object and the vibration period exceeds a predetermined time, the controller in the energy reduction heating apparatus can provide a warning notification about the object. Here, the controller in the energy reduction heating apparatus can set the reference period to be longer as the viscosity of the object is higher.

That is, if the vibration period in the vibration information exceeds the reference period based on the type of the object over a predetermined time, the controller in the energy reduction heating apparatus can determine that the object has been boiled too long that there is a high risk that the object will be charred or burnt, or turn in an undesirable state otherwise, and provide a warning notification about the object through an internal component or to a user terminal. For example, the controller in the energy reduction heating apparatus can output a beep sound through a built-in beep sound speaker, or can transmit a warning notification message about the object to the user terminal.

Also, if the vibration frequency in the vibration information is dropping faster than a predetermined rate, the controller in the energy reduction heating apparatus can determine that the object is being heated too rapidly, and then provide a warning notification about the object.

The embodiments described above can be implemented through computer programs executable through various components on a computer, and such computer programs can be recorded in computer-readable media. In this case, examples of the computer-readable media can include, but are not limited to: magnetic media such as hard disks, floppy disks, and magnetic tape; optical media such as CD-ROM disks and DVD-ROM disks; magneto-optical media such as floptical disks; and hardware devices that are specially configured to store and execute program instructions, such as ROM, RAM, and flash memory devices.

The computer programs can be those specially designed and constructed for the purposes of the present disclosure or they can be of the kind well known and available to those skilled in the computer software arts. Examples of program code include both machine codes, such as produced by a compiler, and higher level code that can be executed by the computer using an interpreter.

As used in the present application (especially in the appended claims), the terms “a/an” and “the” include both singular and plural references, unless the context clearly states otherwise. Also, it should be understood that any numerical range recited herein is intended to include all sub-ranges subsumed therein (unless expressly indicated otherwise) and therefore, the disclosed numeral ranges include every individual value between the minimum and maximum values of the numeral ranges.

The order of individual steps in process claims according to the present disclosure does not imply that the steps must be performed in this order; rather, the steps can be performed in any suitable order, unless expressly indicated otherwise. In other words, the present disclosure is not necessarily limited to the order in which the individual steps are recited. All examples described herein or the terms indicative thereof (“for example,” etc.) used herein are merely to describe the present disclosure in greater detail. Therefore, it should be understood that the scope of the present disclosure is not limited to the embodiments described above or by the use of such terms unless limited by the appended claims. Also, it should be apparent to those skilled in the art that various modifications, combinations, and alternations can be made depending on design conditions and factors within the scope of the appended claims or equivalents thereof

The present disclosure is thus not limited to the example embodiments described above, and rather intended to include the following appended claims, and all modifications, equivalents, and alternatives falling within the spirit and scope of the following claims.

What is claimed is:

1. An energy reduction heating apparatus comprising:
a housing having a storage space;
a heater configured to heat an object;
a power supply configured to supply electric power to the heater;
a top plate disposed at an upper part of the housing and configured to support the object;
a vibration sensor disposed at a lower part of the top plate and configured to sense vibration information of the object; and
a controller configured to control an amount of electric power supplied from the power supply to the heater based on the vibration information.

2. The energy reduction heating apparatus according to claim 1, wherein
the controller is further configured to estimate when the object is in a boiling state based on the vibration information,
the heater comprises a plurality of coils, and
upon estimating the object to be in the boiling state, the controller controls the amount of electric power supplied to the heater by adjusting a number of coils among the plurality of coils supplying electric power based on the vibration information.

3. The energy reduction heating apparatus according to claim 2, wherein the vibration information includes a vibration intensity of the object and a vibration period, and
wherein, upon determining that the vibration intensity sensed by the vibration sensor is higher than a first vibration intensity corresponding to when the object is estimated to be in the boiling state, or that the vibration period is shorter than a first vibration period corresponding to when the object is estimated to be in the boiling state, the controller controls the amount of electric power supplied to the heater by decreasing the number of coils supplying electric power by a predetermined amount.

4. The energy reduction heating apparatus according to claim 2, wherein the vibration information includes a vibration intensity of the object and a vibration period, and
wherein, upon determining that the vibration intensity sensed by the vibration sensor is lower than a first vibration intensity corresponding to when the object is estimated to be in the boiling state, or that a vibration period sensed by the vibration sensor is longer than a first vibration period corresponding to when the object is estimated to be in the boiling state, the controller controls the amount of electric power supplied to the heater by increasing the number of coils supplying electric power by a predetermined amount.

5. The energy reduction heating apparatus according to claim 1, wherein
the vibration information is a vibration pattern comprising at least one of a vibration period, a vibration intensity, or a vibration waveform, and
the controller is further configured to:
confirm a viscosity of the object based on the vibration pattern, and
when a difference between the vibration period and a reference period set in advance based on the confirmed viscosity exceeds a predetermined time, provide a warning notification to a user about the object.

6. The energy reduction heating apparatus according to claim 5, wherein the controller sets the reference period to be longer as the viscosity of the object is higher.

7. The energy reduction heating apparatus according to claim 1, wherein
the vibration information is a vibration pattern comprising at least one of a vibration period, a vibration intensity, or a vibration waveform, and
the controller is further configured to:
identify a type of the object based on the vibration pattern, and
based on the identified type of the object, set an adjustment timepoint at which a number of coils supplying electric power among a plurality of coils of the heater is adjusted.

8. The energy reduction heating apparatus according to claim 7, wherein
the type of the object includes one of a high-viscosity object and a low-viscosity object, the high-viscosity object having a viscosity greater than the low-viscosity object, and
the controller is further configured to define an adjustment delay time as a time period between the adjustment timepoint and a determination timepoint, the determination timepoint being when the vibration intensity sensed by the vibration sensor is determined to be higher than a first vibration intensity corresponding to when the object is estimated to be in the boiling state, and
the controller sets a first adjustment delay time to be longer than a second adjustment delay time, wherein the first adjustment delay time is set when the type of the object is the high-viscosity object, and the second adjustment delay time is set when the type of the object is the low-viscosity object.

9. The energy reduction heating apparatus according to claim 1, wherein
the vibration information is a vibration pattern comprising at least one of a vibration period, a vibration intensity, or a vibration waveform,
the controller is further configured to estimate the boiling state of the object by applying a vibration-based boiling state estimation algorithm to the vibration pattern, and
the vibration-based boiling state estimation algorithm is a neural network model trained to estimate the boiling state of the object based on the vibration pattern generated as the object is heated.

10. The energy reduction heating apparatus according to claim 1, further comprising a transceiver configured to receive images of the object captured at every set period by a camera located within a predetermined distance from the object,
wherein the controller is further configured to estimate that the object is in a boiling state based on the captured images in addition to the vibration information, wherein the boiling state of the object is estimated by applying an image-based boiling state estimation algorithm to the images, and
wherein the image-based boiling state estimation algorithm is a neural network model trained to estimate the boiling state of the object based on changes in an amount of activity in the object, a form of the object, and an amount of vapor, occurring as the object is heated.

11. The energy reduction heating apparatus according to claim 10, wherein the camera is mounted to a kitchen range hood at an angle at which the camera is capable of capturing images of the object.

12. A method of operating an energy reduction heating apparatus, the method comprising:
heating, by a heater in the energy reduction heating apparatus, an object disposed on a top plate of the energy reduction heating apparatus;
sensing vibration information by a vibration sensor in the energy reduction heating apparatus; and
controlling, by a controller of the energy reduction heating apparatus, an amount of electric power supplied to the heater based on the vibration information.

13. The method according to claim 12, wherein
the heater comprises a plurality of coils, and
the controlling the amount of electric power supplied to the heater comprises:
estimating when the object is in a boiling state based on the vibration information; and
upon estimating the object to be in the boiling state, controlling the amount of electric power supplied to the heater by adjusting a number of coils among the plurality of coils supplying electric power, based on the vibration information.

14. The method according to claim 13, wherein the vibration information includes a vibration intensity and a vibration period, and
wherein the controlling the amount of electric power supplied to the heater by adjusting the number of coils supplying electric power comprises, upon determining that the vibration intensity sensed by the vibration sensor is higher than a first vibration intensity corresponding to when the object is estimated to be in the boiling state, or that the vibration period sensed by the vibration sensor is shorter than a first vibration period corresponding when the object is estimated to be in to the boiling state, controlling the amount of electric power supplied to the heater by decreasing the number of coils supplying electric power by a predetermined amount.

15. The method according to claim 13, wherein the vibration information includes a vibration intensity and a vibration period, and
wherein the controlling the amount of electric power supplied to the heater by adjusting the number of coils supplying electric power comprises, upon determining that the vibration intensity sensed by the vibration sensor is lower than a first vibration intensity corresponding to when the object is estimated to be in the boiling state, or that the a vibration period sensed by the vibration sensor is longer than a first vibration period corresponding to when the object is estimated to be in the boiling state, controlling the amount of electric power supplied to the heater by increasing the number of coils supplying electric power by a predetermined amount.

16. The method according to claim 12, wherein
the vibration information is a vibration pattern comprising at least one of a vibration period, a vibration intensity, or a vibration waveform, and
the method further comprises:
confirming a viscosity of the object based on the vibration pattern; and
providing a warning notification about the object when a difference between the vibration period and a reference period set in advance based on the confirmed viscosity exceeds a predetermined time.

17. The method according to claim 16, wherein the reference period is set to be longer as the viscosity of the object is higher.

18. The method according to claim 12, wherein
the vibration information is a vibration pattern comprising at least one of a vibration period, a vibration intensity, or a vibration waveform, and
the controlling the amount of electric power supplied to the heater comprises:
identifying a type of the object based on the vibration pattern; and
based on the identified type of the object, setting an adjustment timepoint at which a number of coils supplying electric power among a plurality of coils of the heater is adjusted.

19. The method according to claim 18, wherein
the type of the object includes one of a high-viscosity object and a low-viscosity object, the high-viscosity object having a viscosity greater than the low-viscosity object, and
the setting the adjustment timepoint at which the number of coils supplying electric power is adjusted comprises:
defining an adjustment delay time as a time period between the adjustment timepoint and a determination timepoint, the determination timepoint being when the vibration intensity sensed by the vibration sensor is determined to be higher than a vibration intensity corresponding to when the object is estimated to be in the boiling state; and
setting a first adjustment delay time to be longer than a second adjustment delay time, wherein the first adjustment delay time is when the type of the object is the high-viscosity object, and the second adjustment delay time is when the type of the object is the low-viscosity object.

20. The method according to claim 12, wherein
the vibration information is a vibration pattern comprising at least one of a vibration period, a vibration intensity, or a vibration waveform,
the controlling the amount of electric power supplied to the heater comprises estimating that the object is in a boiling state by applying a vibration-based boiling state estimation algorithm to the vibration pattern, and
the vibration-based boiling state estimation algorithm is a neural network model trained to estimate the boiling state of the object based on vibration information generated as the object is heated.
